(19) United States
(12) Patent Application Publication
(10) Pub. No.: US 2009/0226364 A1
(43) Pub. Date: Sep. 10, 2009

(54) Process for treating acid gas in staged furnaces with inter-stage heat recovery and inter-stage sulfur production

(75) Inventors: Zeru Berhane Tekie, Newark, DE (US); Luis Alberto Chu, Landenberg, PA (US); Eugene F. Hartstein, Newark, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E. I. du Pont de Nemours and Company, Wilmington, DE (US)

(21) Appl. No.: 12/074,954

(22) Filed: Mar. 7, 2008

(51) Int. Cl. C01B 17/04; B01D 53/48

(52) U.S. Cl. 423/576.2; 423/576.8; 422/182

(57) ABSTRACT

A process for treating acid gases comprising hydrogen sulfide comprises introducing a first acid gas and a first oxygen-containing gas into a reducing furnace to produce a first oxidized gas stream, cooling the first oxidized gas stream in a first heat recovery system, introducing the cooled gas stream into a sulfur condenser to produce a sulfur-stripped gas, introducing the sulfur-stripped gas and a second oxygen-containing gas into an oxidizing furnace to produce a second oxidized gas stream and cooling the second oxidized gas stream in a second heat recovery system. The first acid gas can be acid gas comprising hydrogen sulfide produced in refineries. The spent acid can be spent sulfuric acid from a sulfuric acid alkylation process. The cooled second oxidized gas stream can be further treated in a spent acid recovery plant or a sulfur recovery unit.

### FIELD OF THE INVENTION

The present invention relates to a process for treating an acid gas, more particularly to a process for treating an acid gas comprising hydrogen sulfide.

### BACKGROUND OF THE INVENTION

Petroleum refineries employ many different processes which convert crude oil into hundreds of products. A number of these processes produce sulfur-containing process streams which can be treated to regenerate active ingredients or to recover sulfur values from such streams. Sulfur-containing process streams are generated in hydrotreating processes and sulfuric acid-catalyzed alkylation. Hydrotreating includes hydrocracking and removal of undesirable components, such as sulfur and nitrogen, by distillation and/or hydrodesulfurization or hydrodenitrogenation.

Hydrotreating may generate sour gas streams, which contain valuable hydrocarbons and are rich in acid gas components (e.g., H₂S and CO₂). By “sour” gas streams it is meant herein to describe a stream which comprises an acid gas, typically H₂S. The acid gas components must be removed to “sweeten” the sour gas stream so that the sweetened stream can be sold or used as fuel gas for the refinery's energy needs. The acid gas components must be further treated to comply with environmental regulations.

It is recognized that sour gas streams are not only generated in petroleum refining, but are also generated in natural gas processing and gasification of coal or petroleum coke.

Acid gas generated from refinery and other processes may be treated in either a sulfur recovery unit (SRU), which produces elemental sulfur, or spent acid recovery (SAR) plant, which produces purified sulfuric acid.

Most SRUs are based on the modified-Claus process, consisting of free-flame reaction furnace as the first process unit. Hydrogen sulfide in the acid gas stream fed to the reaction furnace is partially oxidized to produce elemental sulfur. The typical operating temperatures of modern SRU furnaces, that is, 925° C. to 1200° C., limit the equilibrium conversion of H₂S to elemental sulfur to a range of 67% to 74%. The gas stream exiting the SRU reaction furnace is typically cooled through a waste heat exchanger and sulfur condenser for steam generation and sulfur product recovery. Higher sulfur recoveries from sulfur plants are only achieved by processing the cooled and sulfur-stripped gas, containing unreacted H₂S and SO₂, through multiple staged catalytic converters.

In SAR plants with conventional furnaces, acid gases may be directly fed to a spent acid decomposition furnace to serve as fuel source. If the acid gas provides insufficient energy for the amount of spent sulfuric acid to be decomposed, additional fuel, such as natural gas, refinery fuel gas, or other energy source is required. Added fuel is a cost to the plant. If there is excess acid gas relative to the amount of spent acid to be decomposed, too much heat is generated and quench water is added for temperature control. Most of this heat is not recoverable. Added quench water also increases the volume of gas treated downstream, and hence increases equipment size and cost.

Under oxidizing conditions (high temperature and excess oxygen), ammonia-containing acid gases contribute to fuel NOₓ formation. Thus, a conventional furnace has deficiencies that include adding quench water, wasted heat and higher NOₓ formation.

Furthermore, market demand, especially local demand, for sulfur and sulfuric acid produced from acid gas may vary, and it may be desirable to shift production from one product to the other. Current Claus units for producing sulfur and spent acid recovery plants for producing sulfuric acid lack flexibility to easily change their production.

It is desirable to improve the conventional sulfuric acid recovery process to improve heat recovery, minimize need for added fuel, and minimize capital investment, to reduce NOₓ formation and to improve flexibility for producing sulfur and sulfuric acid based on market demands. The present invention provides such a process.

### SUMMARY OF THE INVENTION

The present invention is directed to a process for treating an acid gas comprising hydrogen sulfide and optionally spent acid. The process comprises: (a) introducing a first acid gas, which comprises hydrogen sulfide, and a first oxygen-containing gas into a reducing furnace producing a first oxidized gas stream; (b) introducing the first oxidized gas stream into a first heat recovery system wherein the stream is cooled and heat is recovered therefrom; (c) introducing the cooled first oxidized gas stream to a sulfur condenser wherein elemental sulfur is removed from the stream to produce a sulfur-stripped stream; (d) introducing the sulfur-stripped stream and a second oxygen-containing gas, and optionally one or more of (i) a supplemental fuel, which can be a second acid gas which comprises hydrogen sulfide; (ii) spent acid and (iii) water, into an oxidizing furnace, producing a second oxidized gas stream; and (e) introducing the second oxidized gas stream into a second heat recovery system; wherein the stream is cooled and heat is recovered therefrom.

The acid gas of step (a) can be derived from one or more refinery process streams, which comprise hydrogen sulfide.

A preferred embodiment the process of this invention is a combustion process in a spent acid recovery plant comprising: (a) introducing a first acid gas and a first oxygen-containing gas into a reducing furnace producing a first oxidized gas stream; (b) introducing the first oxidized gas stream into a first heat recovery system wherein the stream is cooled and heat is recovered therefrom; (c) introducing the cooled first oxidized gas stream to a sulfur condenser wherein elemental sulfur is removed from the stream to produce a sulfur-stripped stream; (d) introducing the sulfur-stripped stream, a second oxygen-containing gas, spent acid comprising sulfuric acid, and optionally one or both of (i) a supplemental fuel, which can be a second acid gas, which comprises hydrogen sulfide; and (ii) water, into an oxidizing furnace, producing a second oxidized gas stream; (e) introducing the second oxidized gas stream into a second heat recovery system; wherein the stream is cooled and heat is recovered therefrom, and (f) treating the cooled second oxidized gas stream in a spent acid recovery plant to produce sulfuric acid.

### BRIEF DESCRIPTION OF THE DRAWINGS

FIG. 1 is a process diagram of a conventional process for treating acid gas comprising hydrogen sulfide in a single stage furnace.

FIG. 2 is a process diagram of a process of this invention for treating acid gas comprising hydrogen sulfide in a staged furnace with inter-stage heat recovery and sulfur removal.

### DETAILED DESCRIPTION

Trade names are capitalized herein.

The present invention comprises the use of staged furnaces, with inter-stage heat recovery, and removal of elemental sulfur, for treating an acid gas, for example in sulfuric acid regeneration plants. This invention improves heat recovery, minimizes capital investment, and decreases NOₓ generation compared to the conventional single stage furnace used for burning acid gas as a fuel source and for spent acid decomposition. This process also recovers elemental sulfur (Sₓ) from acid gas. Advantageously, this process can be tailored so that production of recovered sulfur and recovered acid can meet changing market demands.

The process of this invention comprises introducing a first acid gas comprising hydrogen sulfide and a first oxygen-containing gas into a reducing furnace to produce a first oxidized gas stream; introducing the first oxidized gas stream into a first heat recovery system wherein the stream is cooled and heat is recovered therefrom; introducing the cooled first oxidized gas stream into a sulfur condenser to condense and remove sulfur and produce a sulfur-stripped gas stream; introducing the sulfur-stripped gas stream and a second oxygen-containing gas, and optionally, one or more of (i) a second supplemental fuel, which can be an ammonia-free second acid gas; (ii) spent acid and (iii) water, into an oxidizing furnace, producing a second oxidized gas; and introducing the second oxidized gas stream into a second heat recovery system wherein the stream is cooled and heat is recovered. The cooled second oxidized gas comprises sulfur dioxide and may be further treated, for example, by introducing into a spent acid recovery plant for production of purified sulfuric acid, which may be then used in alkylation processes. Alternatively, the cooled second oxidized gas stream may be introduced into a sulfur recovery unit (SRU) for production of elemental sulfur.

Flow generally proceeds through the process due to pressure gradient. That is, pressure of the reducing furnace is higher than pressure of the oxidizing furnace. Preferably, the reducing furnace operates at a pressure slightly above or slightly below atmospheric pressure, for example −1 to 10 psig (−6.9 to 69 kPa gauge). Preferably the oxidizing furnace operates below atmospheric pressure.

In the first step of this invention a first acid gas comprising hydrogen sulfide is introduced into a reducing furnace. While any acid gas comprising hydrogen sulfide may be used, conveniently and advantageously, the acid gas is an acid gas produced as a byproduct in a commercial operation, such as a refinery.

The first acid gas may be or comprise “solvent-treated acid gas”. By “solvent-treated acid gas” it is meant a sour gas stream which has been treated by a regenerative absorption process in which hydrogen sulfide, carbon dioxide and/or other acid gases are absorbed into a non-volatile solvent. Solvents include salt solutions, such as potassium carbonate solution, and alkanolamines, such as monoethanolamine or diethanolamine, and any combination thereof. After absorption, the hydrogen sulfide, carbon dioxide, and/or other acid components, are released from the solvent by pressure reduction, thermal stripping or a combination of the two, to provide a treated gas, referred to herein as “solvent-treated acid gas”. This particular acid gas typically comprises hydrogen sulfide, carbon dioxide and water as the major components, and may also comprise light hydrocarbons and nitrogen. Solvent-treated acid gas typically comprises about 60-85% H₂S, about 10-20% CO₂, with the balance comprising water, nitrogen, and hydrocarbons.

The first acid gas may be or comprise sour water stripper (SWS) gas. Refineries produce SWS gas from treating various “sour” water wash process streams which comprise hydrogen sulfide and ammonia. More specifically, SWS gas is generated when sour water is stripped with steam to remove hydrogen sulfide and ammonia. SWS gas and other acid gases have fuel value due to the presence of hydrogen sulfide, ammonia and light hydrocarbons. SWS gas typically comprises about equal amounts of ammonia, hydrogen sulfide and water.

Preferably the first acid gas is solvent-treated acid gas, SWS gas, or a combination thereof. More preferably, the selection of acid gas and the volume fed is based on the volumes of acid gases available, the volume of spent acid added to the oxidizing furnace; and the energy requirements to achieve the desired temperature. Thus, the treatment of sulfur-containing streams in a refinery can be improved, e.g., by minimizing energy (heat) loss and deriving value from sulfur-containing fuel sources, which have low value to refinery customers.

Use of acid gases such as solvent-treated acid gas and SWS gas is especially preferred when the process of this invention comprises treating spent acid from refining alkylation processes. These gases are readily available, thus they do not add costs to the plant and, after removal from more valuable hydrocarbon streams, they must also be treated to comply with government emission regulations.

Optionally, a first supplemental fuel can be added to the reducing furnace. The first supplemental fuel can be any gas having fuel value or other energy source. Conveniently, the preferred supplemental fuel is process gas. Process gas includes natural gas, refinery fuel gas, and acid gases comprising one or more of hydrogen sulfide, ammonia, and mercaptans. Preferably, the first acid gas provides sufficient energy to the process and no supplemental fuel is added to the reducing furnace.

The first oxygen-containing gas can be any oxygen-containing gas, such as, but not limited to air, oxygen-enriched air or oxygen. Preferably the first oxygen-containing gas is air or oxygen-enriched air. The amount of oxygen-containing air introduced to the reducing furnace is less than the stoichiometric amount required for complete combustion. By “complete combustion” is meant herein oxidation of all of the sulfur-containing compounds to SO₂ and all of the carbon-containing compounds to CO₂. Typically, this amount is about 30-50% of the stoichiometric amount needed for complete combustion.

The reducing furnace and the oxidizing furnace, the latter of which is discussed herein below, comprise a burner and a chamber. Fuel, such as first acid gas and optional first supplemental fuel are mixed with oxygen in the burner and introduced into the chamber as a flame, providing heat energy for reactions to occur within the furnace at the desired reaction temperature. This temperature is preferably above 1100° C., more preferably about 1250° C. to about 1350° C., for example, about 1250° C.

Certain acid gases, such as SWS gas, comprise both hydrogen sulfide and ammonia. At this temperature, under the reducing conditions provided by sub-stoichiometric oxygen in the reducing furnace, ammonia is converted to hydrogen (H₂) and nitrogen (N₂). Even though the temperature is favorable for NOₓ formation, in the presence of sub-stoichiometric oxygen, ammonia and nitrogen are not converted to NOₓ. In contrast, when oxygen is present in greater than stoichiometric amount, NOₓ formation increases.

The reaction of acid gas and oxygen-containing gas in the reducing furnace produces a first oxidized gas stream. The first oxidized gas stream is a partially oxidized gas stream. That is, this stream comprises sulfur- and carbon-containing compounds, which can be converted, upon reaction with additional oxygen, to sulfur dioxide and carbon dioxide, respectively. For example, this stream also comprises hydrogen sulfide and other gases. This stream also comprises elemental sulfur (Sₓ), Although reducing conditions are present in the reducing furnace, this stream may, and typically will comprise SO₂, due to oxidation of sulfur-containing compounds, and CO and CO₂, due to oxidation of carbon-containing compounds. This first oxidized gas stream further comprises one or more of water, carbonyl sulfide, carbon disulfide, and nitrogen.

The sub-stoichiometric oxygen content and temperature in the reducing furnace favor Claus reactions (equations 1 and 2) for thermal conversion of hydrogen sulfide to elemental sulfur.

2 H₂S+3 O₂→2 SO₂+2 H₂O (1)

2x H₂S+x SO₂→3 Sₓ+2x H₂O (2)

The acid gas feed rate, oxygen-containing gas feed rate and temperature of the reducing furnace can be used to control the amount of sulfur produced in the reducing furnace. Hydrogen sulfide which passes to the oxidizing furnace is converted to SO₂, which can be recovered as sulfuric acid.

The first oxidized gas stream is introduced into a first heat recovery system, which is referred to herein as an inter-stage heat recovery system. In the inter-stage heat recovery system, the gas stream is cooled and heat is recovered therefrom. The inter-stage heat recovery system may be any heat recovery system compatible with the gases and plant design. The inter-stage heat recovery system is preferably selected from the group consisting of a waste heat boiler or a process-to-process heat exchanger. For example, the inter-stage heat recovery system is a waste heat boiler when it is desirable to generate steam for other plant needs.

The inter-stage heat recovery system is typically a waste heat boiler, referred to herein as an inter-stage waste heat boiler IWHB. An IWHB generates steam between the reducing furnace and the oxidizing furnace and thereby increases heat recovery relative to a conventional process. Preferably an IWHB is integral to the reducing furnace but can be a separate unit.

The first oxidized gas stream is cooled in the first heat recovery system to a temperature above the temperature at which elemental sulfur, which may be present in the stream, would condense, that is, greater than 310° C. A typical temperature for the cooled gas stream is about 500° C.

The cooled first oxidized gas stream is introduced into a sulfur condenser (e.g., heat exchanger) wherein elemental sulfur (Sₓ) is condensed from the gas stream and removed, thus producing a sulfur-stripped gas stream. The sulfur-stripped gas stream, which comprises hydrogen sulfide and sulfur dioxide and a second oxygen-containing gas are introduced into an oxidizing furnace to produce a second oxidized gas stream, as discussed below.

The gas stream is cooled in the sulfur condenser to a temperature of about 140° C. to about 200° C., to condense the sulfur. At a temperature in the condenser of about 160° C., nearly all of the sulfur content of the cooled first oxidized gas stream is condensed to form molten sulfur. Molten sulfur is separated in the condenser from the sulfur-stripped gas stream. The molten sulfur can be stored for later use or sale.

The sulfur-stripped gas stream, a second oxygen-containing gas and optionally, one or more of (i) a second supplemental fuel, (ii) spent acid and (iii) water, are introduced into an oxidizing furnace comprising a burner and a chamber to produce a second oxidized gas stream. Preferably, at least one of (i) the second supplemental fuel, (ii) spent acid and (iii) water, are introduced into the oxidizing furnace. More preferably, the second supplemental fuel and spent acid are introduced into the oxidizing furnace. Water is added if temperature control is needed.

The second oxygen-containing gas can be the same as the first oxygen-containing gas, that is, any oxygen-containing gas, such as air, oxygen-enriched air or oxygen. Preferably the second oxygen-containing gas is the same as the first oxygen-containing gas and is air or oxygen-enriched air. The amount of oxygen in the oxygen-containing air fed to the oxidizing furnace is greater than the stoichiometric amount required for complete combustion. Sulfur-containing species and carbon-containing compounds present to be oxidized include COS, CS₂, CO and any Sₓ not recovered in the sulfur condenser. Preferably, the greater than stoichiometric amount of oxygen is a slight excess of oxygen, for example, about 2.5 volume % excess (on a dry basis) for complete combustion.

The optional second supplemental fuel is preferably ammonia-free. Ammonia is converted to NOₓ under conditions in the oxidizing furnace. Preferably, a second supplemental fuel is added. Due to the lower temperature of the sulfur-stripped gas stream exiting the condenser, supplemental fuel (preferably, second acid gas) is introduced to the oxidizing furnace to achieve the desired temperature so that hydrogen sulfide and optional spent acid can be decomposed to sulfur dioxide.

The second supplemental fuel is preferably an ammonia-free second acid gas comprising hydrogen sulfide. More preferably the second acid gas is ammonia-free acid gas that is readily available to the process. Still more preferably, the second acid gas is solvent-treated acid gas, that is, acid gas produced from hydrogen sulfide-containing process gas streams in a refinery, as described hereinabove.

Spent acid is optionally introduced to the oxidizing furnace. The spent acid is typically introduced to the oxidizing furnace chamber as a spray, preferably multiple sprays, into the stream produced from the burner. Spent acid as used herein means a stream comprising sulfuric acid, which has become contaminated, e.g., with water and organic compounds, such as organic sulfates and hydrocarbons, during use, and that is subjected to acid recovery. Uses of sulfuric acid include, for example as a catalyst or reagent in petroleum refining and organic syntheses.

In petroleum refining, spent acid is a diluted acid stream that is purged from a sulfuric acid-catalyzed alkylation process, wherein light olefins are combined with isobutane in the presence of sulfuric acid to produce a product mixture suitable for use as motor vehicle fuel. The spent acid comprises about 90% sulfuric acid, between about 2% and about 7% organic sulfates (“acid soluble organics”), and the balance being water. Make-up fresh acid in the alkylation process typically comprises 99% sulfuric acid.

Spent acid may be produced from organic syntheses. Examples of such spent acid include “nitration spent acid” from nitration reactions, “methyl methacrylate waste acid” from methyl methacrylate production, or “caprolactam spent acid” from caprolactam production. Preferably the spent acid is an acid stream produced in a sulfuric acid-catalyzed alkylation process.

Spent acid is preferably introduced to the oxidizing furnace when the process of this invention is a combustion process which comprises introducing and treating the cooled oxidized gas stream from the oxidizing furnace to a spent acid recovery plant.

The second oxygen-containing gas and at least one of (1) at least a portion of the sulfur-stripped gas stream and (2) optional second supplemental fuel are introduced into the burner of the oxidizing furnace to produce the energy necessary to achieve the desired reaction temperature. The amount of the sulfur-stripped gas stream introduced into the burner depends on several factors, including, temperature of the sulfur-stripped gas stream; volume of spent acid; concentration of acid in the spent acid; volume and fuel content (e.g., hydrogen sulfide, unoxidized carbon-containing compounds, such as CO, COS, CS₂ and process carbon-containing compounds) of both sulfur-stripped gas stream and optional second supplemental fuel; and the energy requirements to provide the desired temperature in the oxidizing furnace. All or a fraction of the sulfur-stripped gas stream may be introduced into the burner of the oxidizing furnace. Alternatively, when sufficient second supplemental fuel is introduced to the burner, the sulfur-stripped stream may be introduced directly into the furnace chamber, that is, without passing through the burner.

Because of its lower temperature, the sulfur-stripped gas stream has a quenching effect, i.e., lowers the temperature of the flame, when introduced into the burner of the oxidizing furnace, which also reduces NOₓ formation. Therefore, it may be preferred to introduce at least a portion of the sulfur-stripped gas stream to the burner of the oxidizing furnace. Nonetheless, care must be taken to avoid introducing too much of the cooler (sulfur-stripped) stream into the burner as too much of this stream will compromise the stability of the flame.

The second supplemental fuel, the sulfur-stripped gas stream, or a combination thereof, and second oxygen-containing gas are introduced to the burner of the oxidizing furnace to produce the energy necessary to achieve the desired reaction temperature. This temperature is preferably about 950° C. to about 1100° C., more preferably about 1000 to 1100° C., for example, about 1050° C. At this temperature, under the oxidizing conditions (greater than stoichiometric oxygen in the oxidizing furnace), complete combustion occurs. Temperature is preferably kept below 1100° C. to minimize NOₓ formation.

If necessary, water, as quench water, may be introduced to the oxidizing furnace to reduce temperature. The amount of quench water, if needed, is reduced significantly from that used in the absence of an inter-stage heat recovery system. Advantageously, the use of less quench water to control temperature results in less heat rejected, most of which is not recoverable, in a gas cleaning section of a spent acid recovery (SAR) plant. In addition, minimizing quench water required for temperature control also helps to reduce capital investment due to smaller size requirements of oxidizing furnace, downstream heat recovery systems, and gas cleaning sections of an SAR plant.

Acid gas, which may include second supplemental fuel, and optional spent acid are oxidized in the oxidizing furnace to produce a second oxidized gas stream. In the oxidizing furnace, sulfur-containing compounds, which may include hydrogen sulfide and sulfuric acid, are converted to SO₂. Trace amounts of SO₃ are also produced. Sufficient oxygen is present to oxidize any elemental sulfur (Sₓ), which can plug downstream equipment, to SO₂. The second oxidized gas stream typically comprises SO₂, SO₃, water, N₂, O₂, CO₂ and particulates. Particulates enter the system as a component of the spent acid stream.

The present invention provides flexibility of fuel resources, e.g., in the oxidizing furnace, the use of cooled first oxidized gas stream and/or second supplemental fuel. The present invention further provides this flexibility in a way to improve efficient use of available fuel (first acid gas and supplemental fuels) and to minimize energy (heat) loss.

The second oxidized gas stream is introduced into a second heat recovery system to produce a cooled second oxidized gas stream. In the second heat recovery system, the gas stream is cooled and heat is recovered. The second heat recovery system may be the same or different from the first heat recovery system. That is, the second heat recovery system is preferably selected from the group consisting of a waste heat boiler or a process-to-process heat exchanger. The second heat recovery system is more preferably a waste heat boiler, referred to herein as the main waste heat boiler (MWHB).

The second oxidized gas stream is cooled in the second heat recovery system to a temperature suitable for further processing, e.g., in a spent acid recovery plant to produce sulfuric acid, or in a Claus plant to regenerate elemental sulfur. A typical temperature for this cooled gas stream is about 290-350° C.

A preferred combustion process in a spent acid recovery plant comprises cleaning the cooled stream from the second heat recovery system, for example, in a primary reverse jet scrubber, to remove particulates from the stream. The process further comprises removing water from the cleaned stream; e.g., by condensing water from the gas in a gas cooling tower. SO₃ may be removed with water from the stream in the gas cooling tower to provide a weak acid solution. After removing condensed water, the gas stream may be fed to a second scrubber, e.g., a final reverse jet scrubber, to remove any remaining particulates. The gas stream is then dried, by contacting the gas stream with strong sulfuric acid in a drying tower. The dried gas comprises SO₂, N₂, O₂ and CO₂. Subsequently, SO₂ is oxidized to SO₃ in the presence of a catalyst and SO₃ is absorbed in a circulating stream typically comprising 98-99% sulfuric acid.

Alternatively, the cooled second oxidized gas stream may be introduced to a sulfur recovery unit (SRU) for processing into elemental sulfur.

The present invention is described below in reference to the Figures.

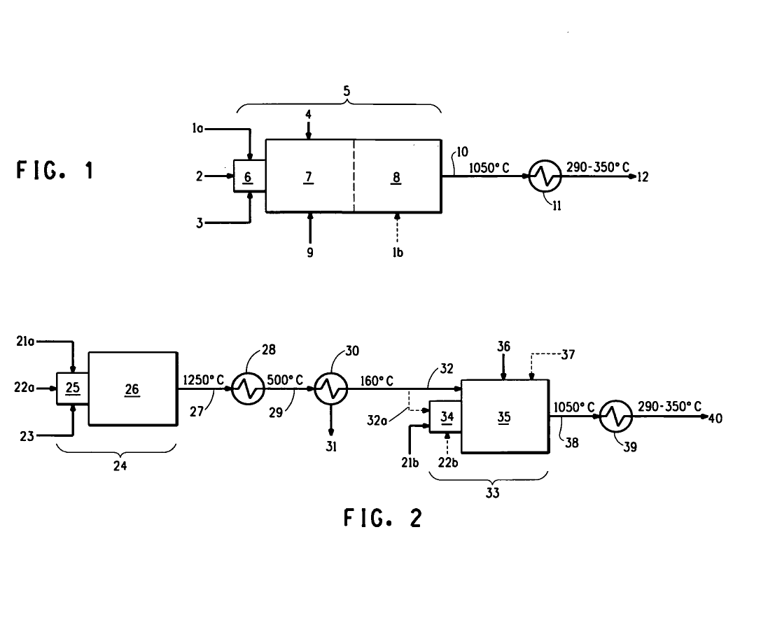

A conventional spent acid recovery (SAR) process utilizes a single stage furnace to decompose sulfuric acid as is shown in FIG. 1. In FIG. 1, first oxygen-containing gas 1a, solvent-treated acid gas 2 and sour water stripper (SWS) gas 3 are introduced to burner 6 of furnace 5 having reducing section 7 and connected to oxidizing section 8. Spent acid 4, which comprises sulfuric acid, is introduced to reducing section 7 of furnace 5. A second oxygen-containing gas 1b is introduced to oxidizing section 8 of furnace 5.

While a reducing section 7 and an oxidizing section 8 are illustrated as two separate sections in furnace 5, these operations may alternatively be combined into a single unit, having only one introduction of oxygen-containing gas. Still further, the “separation” between a reducing section and an oxidizing section may not be physical, e.g., may be merely a difference in oxygen concentration.

The amount of oxygen-containing gas 1a introduced to burner 6 is sub-stoichiometric, that is, less than that required to fully oxidize the sulfur- and carbon-containing compounds present in the streams, typically about 90% by volume, dry basis, for conversion of sulfur-containing compounds to sulfur dioxide and carbon-containing compounds to carbon dioxide. Oxidizing section 8 of furnace 5 is operated under excess oxygen conditions. That is, the amount of oxygen-containing gas 1b added to oxidizing section 8 is greater than that required to fully oxidize the sulfur- and carbon-containing compounds, typically at least about 2.5% excess for conversion of sulfur-containing compounds to sulfur dioxide and carbon-containing compounds to carbon dioxide.

The temperature of furnace 5 is preferably between about 950° C. and about 1100° C. These temperatures are suitable for thermal decomposition of sulfuric acid to sulfur oxides under oxidizing (excess oxygen) conditions. Temperature is achieved by the energy produced from burning solvent-treated acid gas 2 and SWS gas 3, which each comprise hydrogen sulfide as a fuel source. If the energy exceeds the requirements for thermal decomposition of spent acid 5, temperature increases and quench water 9 is added to reducing section 7 to control temperature of furnace 5, to between about 950° C. and about 1100° C. Addition of quench water 9 is common in industry practice.

While conditions of temperature (between about 950° C. and 1100° C.) and excess oxygen are suitable for decomposition of sulfuric acid to sulfur oxides, these conditions are not preferred for conversion of ammonia to nitrogen and hydrogen. That is, when ammonia is present in one or more feeds to furnace 5, such as SWS gas 3, some of the ammonia is converted to nitrogen oxides (NOₓ). In addition, especially at higher temperatures and excess oxygen, when oxygen-containing gases 1a and 1b comprise nitrogen (e.g., air or oxygen-enriched air), nitrogen may also be converted to NOₓ.

Reaction of oxygen-containing gases with solvent-treated acid gas 2, SWS gas 3, and spent acid 4 in furnace 5 produces oxidized gas stream 10, which comprises sulfur oxides, SO₂ (predominant sulfur oxide) and SO₃ (typically present in small amounts). Stream 10 is introduced into heat recovery system 11, such as a waste heat boiler, conventionally referred to as the main waste heat boiler (MWHB), to recover heat from the process, producing cooled oxidized gas stream 12. Cooled stream 12 may be further processed according to known methods (not shown) for spent acid recovery which include, for example, cleaning the cooled oxidized gas stream 12 (to remove particulates), removing water from the cleaned stream, oxidizing SO₂ to SO₃, and absorbing SO₃ in a circulating stream typically comprising 98-99% sulfuric acid.

Notable disadvantages of the conventional process illustrated in FIG. 1 include the following. The addition of quench water 9 increases volume of the oxidized gas stream, which must be treated downstream. Due to increased volume of the stream, sizes of the combustion furnace 5, and downstream equipment, such as heat recovery systems, and gas cleaning equipment (not shown), must be increased, which in turn, increase costs. Since oxidized gas stream 10 is cooled in heat recovery system 11 (MWHB) to between about 290° C. to about 350° C., all of the latent heat and part of the sensible heat of the steam generated from quench water 9 in furnace 5 is lost.

Therefore, a conventional furnace 5 for a spent acid recovery (SAR) process, as illustrated in FIG. 1 having reducing section 7 and oxidizing section 8, has deficiencies that include a need for quench water 9, increased equipment size, wasted heat and excessive NOₓ formation. Furthermore, there is no provision for recovering heat energy and removing elemental sulfur as a valuable product with staged furnaces and cooling.

The process of the present invention mitigates the above deficiencies. One embodiment of the process of this invention is illustrated in FIG. 2. The process according to FIG. 2 comprises introducing a sulfur-containing acid gas sequentially through a reducing furnace 24 and an oxidizing furnace 30 separated by an inter-stage heat recovery system 28 and a sulfur condenser 30.

The process according to FIG. 2 comprises introducing a first acid gas, which comprises solvent-treated acid gas 22a (first solvent-treated acid gas) and sour water stripper (SWS) gas 23, and first oxygen-containing gas 21a to burner 25 of reducing furnace 24, which has combustion chamber 26. Ammonia in SWS gas 23 is reduced to nitrogen and hydrogen in reducing furnace 24.

Exiting reducing furnace 24 is first oxidized gas stream 27, which comprises H₂S, SO₂, Sₓ, H₂O, H₂, CO, CO₂, COS, CS₂, N₂, at a temperature of about 1250° C. First oxidized gas stream 27 is introduced into first heat recovery system 28, which, is an inter-stage waste heat boiler (IWHB). As illustrated, heat recovery system 28 is a separate unit from reducing furnace 24. Cooled first oxidized gas stream 29 exits heat recovery system 28 at a temperature of about greater than about 310° C., for example, 500° C.

Cooled first oxidized gas stream 29 is introduced into sulfur condenser 30. Molten sulfur 31 is separated from the gas stream and exits condenser 30. Sulfur-stripped gas stream 32, from which at least a portion of the elemental sulfur in cooled first oxidized gas stream 29 has been removed, exits condenser 30 at a temperature of about 140° C. to about 200° C.

Sulfur-stripped gas stream 32 is introduced into oxidizing furnace 33. At least a portion of sulfur-stripped gas stream 32 is introduced directly into oxidizing furnace chamber 35 of oxidizing furnace 33. A portion of sulfur-stripped gas stream 32a is introduced to burner 34 of oxidizing furnace 33 along with second oxygen-containing gas 21b and second supplemental fuel 22b, which is a second acid gas, more specifically, a second solvent-treated acid gas. No SWS gas, which comprises ammonia, is introduced into oxidizing furnace 33. Spent acid 36 is introduced into oxidizing furnace chamber 35 of oxidizing furnace 33. In addition, quench water 37, is available to add as needed, to cool temperature of oxidizing furnace 33.

Reactions in oxidizing furnace 33 of oxygen with sulfur-stripped gas stream 32, spent acid 36 and second supplemental fuel (second solvent-treated gas) 22b produce second oxidized gas stream 38. Second oxidized gas stream 38 comprises SO₂, SO₃, water, N₂, O₂, and CO₂. Stream 38 exits oxidizing furnace 33 at a temperature of about 1050° C.

Second oxidized gas stream 38 is introduced into second heat recovery system 39, to recover heat from the process, producing cooled second oxidized gas stream 40. Second heat recovery system 39 is a waste heat boiler (WHB), similar to the main waste heat boiler (MWHB), per FIG. 1, heat recovery system 11, and may be also referred to as MWHB in FIG. 2. Cooled stream 40 exits second heat recovery system 39 at a temperature of about 290-350° C. Cooled stream 40 may be further processed according to known methods (not shown) for spent acid recovery which include, for example, cleaning the cooled stream 40 (to remove particulates), removing water from the cleaned stream, oxidizing SO₂ to SO₃, and absorbing SO₃ in a circulating stream typically comprising 98-99% sulfuric acid.

In comparison to SAR technology for treating acid gas, the process of the present invention minimizes NOₓ generation by converting ammonia in refinery sour water stripper gas to nitrogen and hydrogen in a reducing furnace separated from an oxidizing furnace by an inter-stage heat recovery system and a sulfur condenser. The reducing furnace operates under highly reducing conditions and at a temperature to minimize fuel and thermal NOₓ compared to the conventional processes, in which ammonia is exposed to excess oxygen.

Heat recovery using a first heat recovery system in the process of this invention allows excess heat to be recovered, for example, as valuable steam when a waste heat boiler is used or for use in other processes, and, at the same time helps minimize the quench water requirement, which is used for temperature control in the oxidizing furnace. Use of less water to control temperature results in less heat rejected, which is not recoverable. Additionally, minimizing quench water helps reduce capital investment related to size of the oxidizing furnace, second heat recovery system and other downstream equipment by reducing volumetric gas flow.

Still further, the process of this invention provides for recovery of sulfur values from acid gases comprising hydrogen sulfide as elemental sulfur (Sₓ) and as sulfuric acid. By control of feeds of acid gas and oxygen-containing gas, the relative amounts of elemental sulfur and sulfuric acid produced, when the process is coupled with a spent acid recovery (SAR) plant, can be varied.

### EXAMPLES

The processes shown in FIGS. 1 and 2 were simulated in Comparative Example A (an embodiment of a process having a conventional single-stage furnace of the prior art) and in Example 1 (an embodiment of a process having two-stage furnace with inter-stage heat recovery and sulfur recovery of the present invention), respectively, using ASPEN PLUS (from Aspen Technology, Inc., Cambridge, Mass.). The ASPEN PLUS simulation software is used to evaluate engineering concepts. Table 1 shows the feed components and their compositions, temperatures and flow rates used in the computer simulation. The feed compositions are within the range of typical compositions which may be available in a refinery. In all simulations, air was used as the oxygen-containing gas. All feed pressures were 10 psig (24.7 psia, 170 kPa).

TABLE 1

| Feed | Feed | Flow Rate | | Flow Rate | | |
|---|---|---|---|---|---|---|
| Component | Temp. | Comparative Ex. A | | Example 1 | | Feed Composition |
| Spent Acid | 72° F. | 25000 | lb/h | 25000 | lb/h | 90% H₂SO₄, 3% H₂O, |
| | (22° C.) | (11340 | kg/h) | (11340 | kg/h) | 7% Organic (weight %) |
| First | 120° F. | 764 | lb mol/h | 295 | lb mol/h | 82% H₂S, 12% CO₂, |
| solvent- | (49° C.) | (345 | kg mol) | (134 | kg/h) | 6% H₂O (mole %) |
| treated gas | | | | | | |
| SWS gas | 185° F. | 88 | lb mol/h | 88 | lb mol/h | 33.4% H₂S, 33.3% NH_{3,} |
| | (85° C.) | (40 | kg mol/h) | (40 | kg mol/h) | 33.3% H₂O (mole %) |
| Second | 120° F. | 0 | | 458 | lb mol/h | 82% H₂S, 12% CO₂, |
| solvent- | (49° C.) | | | (208 | kg mol/h) | 6% H₂O (mole %) |
| treated gas | | | | | | |
| Total acid | | 852 | lb mol/h | 852 | lb mol/h | |
| gas | | (385 | kg mol/h) | (385 | kg mol/h) | |
| First O₂- | 95° F. | 6240 | lb mol/h | 871 | lb mol/h | 77.0% N₂, 20.5% O₂, |
| containing | (35° C.) | (2830 | kg mol/h) | (395 | kg mol/h) | 2.5% H₂O (mole %) |
| gas | | | | | | |
| Second O₂- | 95° F. | | | 4389 | lb mol/h | 77.0% N₂, 20.5% O₂, |
| containing | (35° C.) | | | (1991 | kg mol/h) | 2.5% H₂O (mole %) |
| gas | | | | | | |
| Total O2- | | 6240 | lb mol/h | 5260 | lb mol/h | |
| containing | | (2830 | kg mol/h) | (2386 | kg mol/h) | |
| gas | | | | | | |

In simulated Comparative Example A, first acid gas 2, which is solvent-treated acid gas, SWS gas 3, and first oxygen-containing gas 1a, which is air, were fed to burner 6 of reducing section 7 of furnace 5. Spent acid 4 was introduced into reducing section 7 of furnace 5. No oxygen-containing gas was introduced into oxidizing section 8 of furnace 5. Quench water 9 was introduced into reducing section 7 of furnace 5 to control temperature at <1100° C. Oxidized gas stream 10 exited furnace 5 and was introduced into heat recovery system 11, to recover heat.

In simulated Example 1, first acid gas 22a, which is solvent-treated acid gas and first oxygen-containing gas 21a, which is air, were fed to burner 25 of reducing furnace 24. Stream 27 exiting reducing furnace 24 was fed to a first heat recovery system 28, to cool the stream and recovery heat. The cooled stream 29 was fed to sulfur condenser 30 to further cool the stream and remove sulfur. Sulfur-stripped stream 32, second acid gas 22b (supplemental fuel, which is solvent-treated acid gas), and second oxygen-containing gas 21b, which is air, were fed to burner 34 of oxidizing furnace 33. Spent acid 36 was fed into chamber 35 of oxidizing furnace 33. Quench water 37 was fed to oxidizing furnace 33 to control temperature to less than 1100° C. Oxidized gas stream 38 exited furnace 33 and also was introduced into second heat recovery system 39, to recover heat.

ASPEN PLUS simulation was used to calculate (1) quench water requirement to maintain temperature in the oxidizing furnace less than 1100° C.; (2) the heat recovered from individual and combined heat recovery systems, including sulfur condenser, as both “Sulfur Condenser” and “Equivalent Heat from Sulfur Condensed” and (3) gas mole flow exiting (i) the oxidizing section 8 of the furnace for the prior art process of FIG. 1 (Comparative Example A) and (ii) the oxidizing furnace 33 for the process of FIG. 2 (Example 1). The calculations based on the simulations are shown in Table 2.

The first heat recovery system 28 of Example 1, is an inter-stage waste heat boiler (IWHB) and the heat recovered is referred to in Table 2 as IWHB Heat Recovery. The heat recovery system 11 of Comparative Example A and the second heat recovery system 39 of Example 1 are main waste heat boilers (MWHBs) and the heat recovered for each Example is referred to in Table 2 as MWHB Heat Recovery. Heat recovered from sulfur condenser 30 is referred to in Table 2 as Sulfur Condenser Heat Recovery. Equivalent Heat from Sulfur Condensed, which means the energy content of the sulfur condensed, is also provided in Table 2. Total Heat Recovery is the sum of IWHB, MWHB and Sulfur Condenser heat recoveries and Equivalent Heat from Sulfur Condensed.

The gas mole flow exiting the oxidizing section 8 (Comparative Example A) is oxidized gas stream 10. The gas mole flow exiting the oxidizing furnace 33 (Example 1) is second oxidized gas stream 38. The gas mole flow exiting the oxidizing section 8 and the oxidizing furnace 33 are referred to in Table 2 as “Oxidized gas stream flow”. The gas mole flow from the oxidizing section 8 or oxidizing furnace 33 controls the equipment sizing of spent acid recovery (SAR) plant equipment down stream of the oxidizing section or oxidizing furnace. Therefore, minimizing this flow helps to minimize capital investment of an SAR plant.

TABLE 2

| | Comparative | | | |
|---|---|---|---|---|
| Flow Rates and Heat Recoveries | Ex. A | | Example 1 | |
| Quench Water Flow, gal/min. (L/min.) | 35 | (131) | <1 | (<3.8) |
| IWHB Recovery, 10⁶ btu/h | Not Applicable | | 15 | (5) |
| (MW) | | | | |
| MWHB Heat Recovery, 10⁶ btu/h | 97 | (28) | 73 | (21) |
| (MW) | | | | |
| Sulfur Condenser Heat Recovery, 10⁶ | Not applicable | | 7 | (2.0) |
| btu/h (MW) | | | | |
| Equivalent Heat from Sulfur Condensed | Not applicable | | 21 | (6) |
| (Energy Content of Sulfur Condensed), | | | | |
| 10⁶ btu/h (MW) | | | | |
| Total Heat Recovery, 10⁶ btu/h | 97 | (28) | 116 | (34) |
| (MW) | | | | |
| Oxidized gas stream flow, lb mol/h | 8332 | (3779) | 6390 | (2898) |
| (kg mol/h) | | | | |

Table 2 shows Comparative Example A (process using conventional furnace of the prior art), 35 gal/min. (131 L/min.) of quench water is needed to maintain the temperature of the furnace less than 1100° C. In contrast, temperature can be maintained in Example 1 (process of this invention with two stage furnace, inter-stage cooling and sulfur condensing) at less than 1 gal/min. (<3.8 L/min.). The mole flow of the oxidized gas from the oxidizing furnace in Example 1 was less, despite the same amount of Total acid gas fed in both Examples, since less quench water as well as oxygen-containing gas, were added and a portion of the sulfur was condensed in Example 1 relative to Comparative Example A.

Example 1 also has higher heat recovery from the heat recovery systems and lower molar flow of the oxidized gas stream than Comparative Example A.

Example 1 also allowed for recovery of elemental sulfur unlike Comparative Example A. In Example 1, 30% of the sulfur content of the total of the solvent-treated acid gas and sour water stripper fed to the reducing furnace was recovered as elemental sulfur. The amount of sulfur recovered was determined by the amount of amine gas fed to the reducing furnace.

What is claimed is:

1. A process for treating an acid gas comprising hydrogen sulfide which comprises:
(a) introducing a first acid gas, which comprises hydrogen sulfide, and a first oxygen-containing gas into a reducing furnace producing a first oxidized gas stream;
(b) introducing the first oxidized gas stream into a first heat recovery system wherein the stream is cooled and heat is recovered therefrom;
(c) introducing the cooled first oxidized gas stream to a sulfur condenser wherein elemental sulfur is condensed and removed from the stream to produce a sulfur-stripped stream;
(d) introducing the sulfur-stripped stream and a second oxygen-containing gas, into an oxidizing furnace, producing a second oxidized gas stream; and
(e) introducing the second oxidized gas stream into a second heat recovery system; wherein the stream is cooled and heat is recovered therefrom.

2. The process of claim 1 wherein one or more of (i) a supplemental fuel, which can be a second acid gas comprising hydrogen sulfide, (ii) spent acid, which comprises sulfuric acid, and (iii) quench water, are introduced into the oxidizing furnace in step (d).

3. The process of claim 2 wherein step (d) further comprises introducing spent acid into the oxidizing furnace.

4. The process of claim 3 wherein the spent acid is a dilute acid stream produced in a sulfuric acid alkylation process, nitration spent acid, methyl methacrylate waste acid, or caprolactam spent acid.

5. The process of claim 4 wherein the spent acid is a diluted acid stream produced in a sulfuric acid alkylation process.

6. The process of claim 3 further comprising treating the cooled second oxidized gas stream in a spent acid recovery plant to produce sulfuric acid.

7. The process of claim 1 further comprising treating the cooled second oxidized gas stream in a sulfur recovery unit.

8. The process of claim 1 wherein the first acid gas is solvent-treated acid gas, sour water stripper gas, or a combination thereof.

9. The process of claim 2 wherein a supplemental fuel, which is a second acid gas comprising hydrogen sulfide, is introduced into the oxidizing furnace in step (d).

10. The process of claim 9 wherein the supplemental fuel is solvent-treated acid gas.

11. The process of claim 1 wherein the temperature of the reducing furnace is in the range of 1100° C. to 1350° C. and the temperature of the oxidizing furnace is in the range of 950° C. to 1100° C.

12. The process of claim 11 wherein the amount of oxygen-containing gas in the reducing furnace is about 30-50% of the stoichiometric amount for oxidation of all of the sulfur-containing compounds to SO₂ and all of the carbon-containing compounds to CO₂.

13. The process of claim 1 wherein the first heat recovery system is a waste heat boiler or a process-to-process heat exchanger.

14. The process of claim 13 wherein the first heat recovery system is a waste heat boiler.

15. The process of claim 1 wherein the second heat recovery system is a waste heat boiler or a process-to-process heat exchanger.

16. The process of claim 16 wherein the second heat recovery system is a waste heat boiler.

17. A combustion process in a spent acid recovery plant for treating an acid gas comprising hydrogen sulfide which comprises:
(a) introducing a first acid gas, which comprises hydrogen sulfide, and a first oxygen-containing gas into a reducing furnace producing a first oxidized gas stream;
(b) introducing the first oxidized gas stream into a first heat recovery system which is a waste heat boiler, wherein the stream is cooled and heat is recovered therefrom;
(c) introducing the cooled first oxidized gas stream to a sulfur condenser wherein elemental sulfur is removed from the stream to produce a sulfur-stripped stream;
(d) introducing the sulfur-stripped stream, a second oxygen-containing gas, and spent acid comprising sulfuric acid into an oxidizing furnace, producing a second oxidized gas stream; and
(e) introducing the second oxidized gas stream into a second heat recovery system; wherein the stream is cooled and heat is recovered therefrom; and

18. The process of claim 17 wherein one or both of (i) a supplemental fuel, which can be a second acid gas comprising hydrogen sulfide, and (ii) water, are introduced into the oxidizing furnace in step (d).

19. The process of claim 18 wherein the spent acid is a dilute acid stream produced in a sulfuric acid alkylation process.

20. The process of claim 18 wherein a supplemental fuel is introduced into the oxidizing furnace in step (d).

21. The process of claim 20 wherein the supplemental fuel is an ammonia-free acid gas.

22. The process of claim 20 wherein the supplemental fuel is solvent-treated acid gas.

23. The process of claim 17 further comprising treating the cooled second oxidized gas stream in a spent acid recovery plant to produce sulfuric acid.
